(19) United States
(12) Patent Application Publication
(10) Pub. No.: US 2020/0313472 A1
(43) Pub. Date: Oct. 1, 2020

(54) ELECTRIC MACHINES HAVING CORES WITH DISTRIBUTED POLES

(71) Applicant: Hamilton Sundstrand Corporation, Charlotte, NC (US)

(72) Inventors: Joseph Kenneth Coldwate, Roscoe, IL (US); Andreas C. Koenig, Rockford, IL (US)

(21) Appl. No.: 16/363,601

(22) Filed: Mar. 25, 2019

(51) Int. Cl. H02K 1/14; H02K 3/18; H02K 3/46; H02K 15/06

(52) U.S. Cl. CPC H02K 1/14; H02K 15/062; H02K 3/46; H02K 3/18

(57) ABSTRACT

A core for an electric machine includes a core body arranged along a rotation axis and a winding. The core body has two or more teeth including a first tooth and a second tooth that are circumferentially spaced from one another about the rotation axis. The winding is to the core body and includes two or more coils connected electrically in series with one another. A first of the coils is seated circumferentially about both the first tooth and the second tooth to define a distributed pole circumferentially spanning both the first tooth and the second tooth. Electric machines and methods of making cores for electric machines are also described.

### BACKGROUND

The subject matter disclosed herein generally relates to electric machines, and more particularly to electric machine cores having distributed poles.

Electrical systems, such as aircraft electrical systems, commonly include generators. The generators provide electrical power to electrical devices connected to the electrical systems, generally by rotating magnetic elements relative to a stationary winding. As the magnetic elements rotate magnetic flux is communicated between the magnetic elements and the stationary winding, the magnetic flux inducing current flow in the stationary winding for powering electrical devices connected to the generator.

In some generators the magnetic flux is provided by flowing an electric current through coils of wire wrapped about a ferromagnetic structure. The current flow magnetizes the portion of the ferromagnetic structure the wire wraps about to define a magnetic pole including the ferromagnetic structure. Once magnetized, the pole communicates magnetic flux to the stationary winding, the magnetic flux in turn inducing current flow in the stationary winding. Typically, the ferromagnetic structure about which the wire is coiled is a single, continuous ferromagnetic structure. In addition, the pole is generally formed using a single coil wrapped about the single ferromagnetic structure to impart both uniformity and symmetry to the pole.

Such generators and methods of making generators having generally been satisfactory for their intended purpose. However, there remains a need in the art for improved cores for electric machines, electric machines, and methods of defining poles in electric machines. The present disclosure provides a solution to this need.

### BRIEF SUMMARY

According to one embodiment, a core for an electric machine is provided. The core includes a core body arranged along a rotation axis. The core body has two or more teeth including at least a first tooth and a second tooth circumferentially spaced from one another about the rotation axis. A winding is fixed to the core body and has two or more coils connected electrically in series with one another, one of the of coils seated circumferentially about both the first tooth and the second tooth to define a distributed pole circumferentially spanning both the first tooth and the second tooth.

In addition to one or more of the features described above, or as an alternative, further embodiments may include a current source in electrical communication with the winding, wherein the winding defines a plurality of distributed poles arranged circumferentially about the rotation axis.

In addition to one or more of the features described above, or as an alternative, further embodiments may include wherein each of the plurality of distributed poles of the core is defined by two or more teeth of the core.

In addition to one or more of the features described above, or as an alternative, further embodiments may include wherein each of the plurality of distributed poles is defined by two or more coils of the winding.

In addition to one or more of the features described above, or as an alternative, further embodiments may include wherein the winding and the core body cooperatively define twelve (12) distributed poles, wherein the core body has twenty-four (24) teeth, and wherein the winding has twenty-four (24) coils.

In addition to one or more of the features described above, or as an alternative, further embodiments may include wherein the first tooth has a first circumferential span, wherein the second tooth has a second circumferential span, and wherein the second circumferential span is equivalent to the first circumferential span.

In addition to one or more of the features described above, or as an alternative, further embodiments may include wherein the first tooth has a first circumferential span, wherein the second tooth has a second circumferential span, and wherein the second circumferential span is greater than the first circumferential span.

In addition to one or more of the features described above, or as an alternative, further embodiments may include wherein the first coil comprises a plurality of first coil turns, wherein the second coil comprises a plurality of second coil turns, wherein the plurality of second coil turns is equivalent to the plurality of first coil turns.

In addition to one or more of the features described above, or as an alternative, further embodiments may include wherein in the core comprises a plurality of laminations axially stacked along the rotation axis, and further comprising a shaft arranged along the rotation axis, the core body seated on the shaft.

In addition to one or more of the features described above, or as an alternative, further embodiments may include wherein the winding is one of a field winding, an excitation winding, or a control winding.

In addition to one or more of the features described above, or as an alternative, further embodiments may include a damper winding seated in the core body.

In addition to one or more of the features described above, or as an alternative, further embodiments may include wherein the core has no permanent magnets fixed to the core body.

According to another embodiment, an electric machine is provided. The electric machine includes a stator with a stator winding, a core as described above, and a current source. The stator extends about the rotation axis, the core is supported for rotation about the rotation axis relative to the stator, and the current source in electrical communication with the winding.

In addition to one or more of the features described above, or as an alternative, further embodiments may include that the winding and the rotor cooperate to generate a sinusoidal voltage waveform for an alternating current electrical load connected to the stator winding.

In addition to one or more of the features described above, or as an alternative, further embodiments may include that the winding and the rotor cooperate to generate a trapezoidal voltage waveform for a direct current electrical load connected to the stator winding.

In addition to one or more of the features described above, or as an alternative, further embodiments may include one of an alternating current electrical load and a direct current electrical load connected to the stator winding.

According to another embodiment, a method of making a core for an electric machine is provided. The method includes, at core body as described above, fixing a winding fixed to the core body, wherein fixing the winding to the core body includes seating a first of the plurality of coils circumferentially about both the first tooth and the second tooth to define a distributed pole circumferentially spanning both the first tooth and the second tooth, and connecting the plurality of coils electrically in series with one another.

In addition to one or more of the features described above, or as an alternative, further embodiments may include shaping the distributed pole by forming the first tooth with a first circumferential span and the second tooth with a second circumferential span greater than the first circumferential span.

In addition to one or more of the features described above, or as an alternative, further embodiments may include shaping the distributed pole by forming the first coil with a greater number of turns than the second coil.

Technical effects of embodiments of the present disclosure include the capability to shape the magnetic poles defined within an electric machine. In certain embodiments shaping is accomplished by arrangement of a coil circumferentially about two or more teeth the electric machine core. In accordance with certain embodiments shaping is accomplished by forming the teeth such that one of two circumferentially adjacent teeth has a greater pole arc than another of the two circumferentially adjacent teeth, and the coil wrapped about both the two circumferential teeth. It is also contemplated that the shaping can be accomplished by wrapping two or more coils about the teeth defining the magnetic pole such that one of the two or more coils has a greater number of turns than another of the two or more coils. In addition, technical effects include the capability to provide relatively large pole arc in relation to coil and wedge size.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF DRAWINGS

The following descriptions should not be considered limiting in any way. With reference to the accompanying drawings, like elements are numbered alike:

FIG. 1 is a schematic view of an electrical system having a generator-type electric machine constructed in accordance with the present disclosure, showing the generator providing current power to electrical loads using a sinusoidal voltage waveform or a trapezoidal voltage waveform defined by distributed poles of the generator core;

FIG. 2 is a cross-sectional axial view of a core of the generator of FIG. 1, showing a core body arranged along a rotation axis with teeth and a winding formed from a plurality of coils wrapped about the teeth;

FIG. 3 is a schematic view of a core for the generator shown in FIG. 1 according to an embodiment, showing distributed poles of the core cooperatively defined by teeth having equivalent circumferential span and coils with equivalent numbers of turns;

FIG. 4 is a schematic view of a core for the generator shown in FIG. 1 according to another embodiment, showing distributed poles of the core defined by teeth having different circumferential spans;

FIG. 5 is schematic view of a core for the generator shown in FIG. 1 according to yet another embodiment, showing distributed poles of the core defined by coils having different numbers of turns;

FIG. 6 is a cross-sectional axial view of a core for the generator shown in FIG. 1, showing a core having twelve (12) distributed poles defined by twenty-four (24) winding coils and twenty-four (24) core teeth, according to an embodiment; and

FIG. 7 is a block diagram of a method of making a core for an electric machine, showing operations of the method.

### DETAILED DESCRIPTION

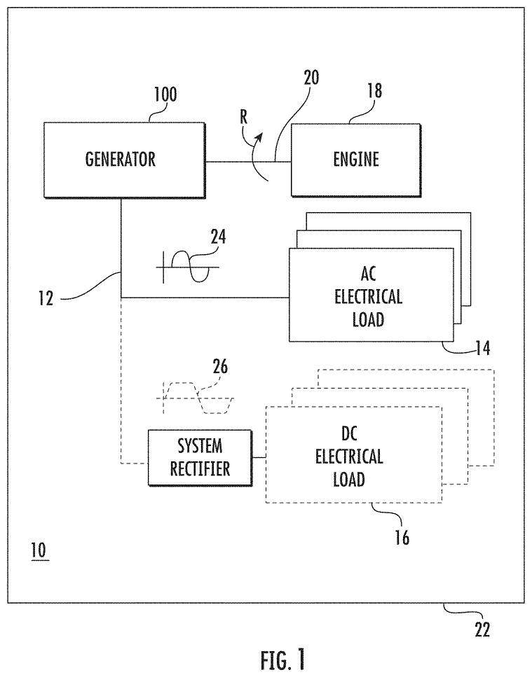

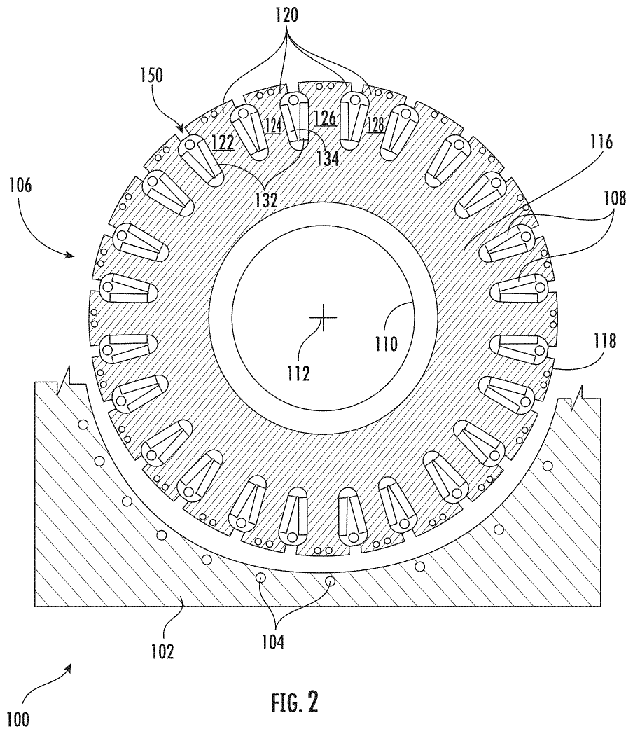

Reference will now be made to the drawings wherein like reference numerals identify similar structural features or aspects of the subject disclosure. For purposes of explanation and illustration, and not limitation, a partial view of an exemplary embodiment an electric machine in accordance with the present disclosure is shown in FIG. 1 and is designated generally by reference character 100. Other embodiments of cores for electric machines, electric machines, and methods of making cores for electric machines in accordance with the present disclosure, or aspects thereof, are provided in FIGS. 2-7, as will be described. The systems and methods described herein can be used for generator-type electric machines in aircraft electrical systems, though the present disclosure is not limited to aircraft electric systems or to any particular type of electric machine in general.

Referring to FIG. 1, an electrical system 10 is shown. The electrical system, 10 includes the generator-type electric machine (generator) 100, a power distribution bus 12, and one or more electrical load, e.g., an alternating current (AC) electrical load 14 or a direct current (DC) electrical load 16, which is connected to the electric machine 100. The electric machine 100 is operatively associated with an engine 18 and receives mechanical rotation R from the engine 18 to generate electric power, e.g., AC power with a sinusoidal voltage waveform 24 for the AC electrical load 14 or DC power with a trapezoidal voltage waveform 26 for the DC electrical load 16. As shown in FIG. 1 the electrical system 10 is an aircraft electrical system and the engine 18 is an aircraft main engine or auxiliary power unit connected to the generator-type electric machine 100 by an accessory gearbox 20 carried by an aircraft 22. Although shown and described herein in the context of an aircraft electrical system, it is to be understood and appreciated that other types of electrical systems, e.g., terrestrial vehicles and fixed electrical systems, and electric machines, e.g., motors, can also benefit from the present disclosure.

With reference to FIG. 2, the electric machine 100 is shown. The electric machine 100 includes a stator 102 with a stator winding 104, a core 106 with a core winding 108, and shaft 110. The stator 102 extends about a rotation axis 112 and supports the stator winding 104. The stator winding 104 is in electrical communication with power distribution bus 12 (shown in FIG. 1). The shaft 110 is supported for rotation about the rotation axis 112 relative to the stator 102. The core 106 includes a core body 114 and is seated on the shaft 110.

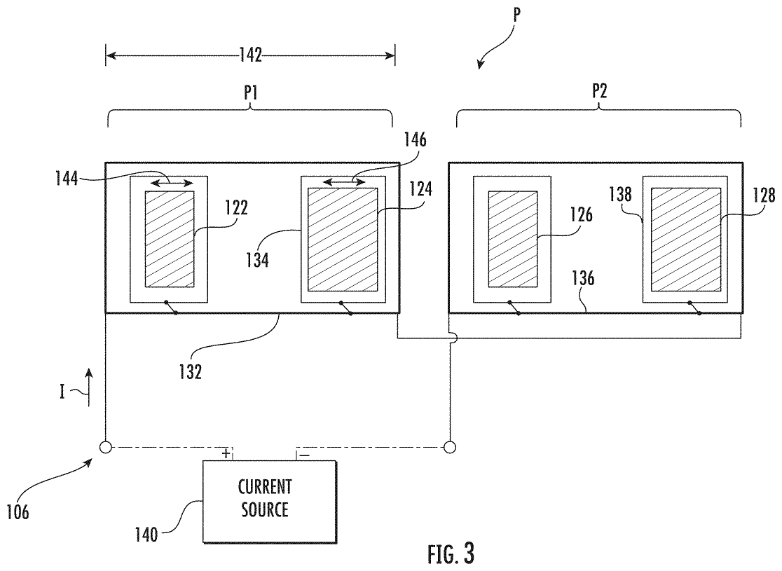

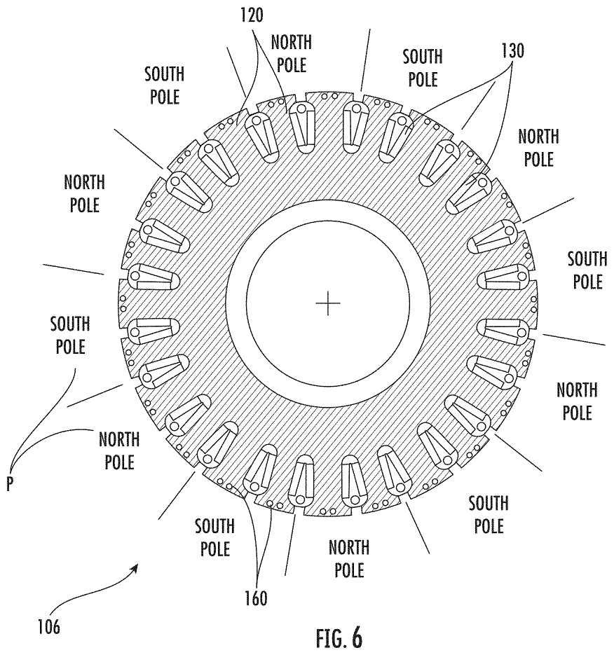

The core body 114 is formed from a ferromagnetic material 116 and includes a plurality of laminations 118 axially stacked along the rotation axis 112. A plurality of rotor teeth 120 are distributed circumferentially about the radially outer periphery of the core body 114 and are circumferentially spaced apart from one another by axial gaps 150. It is contemplated that the plurality of rotor teeth cooperate with the core winding 108 and a current flow I (shown in FIG. 3) provided to the core winding 108 to define distributed poles P (shown in FIG. 6) of the core 106. In this respect a first tooth 122 and a circumferentially adjacent second tooth 124 cooperate with the core winding 108 to define a first distributed pole P1 (shown in FIG. 3). A third tooth 126 and a fourth tooth 128 cooperate with the core winding 108 to define a distributed pole P2 (shown in FIG. 3).

The core winding 108 is fixed to the core body 114 and includes a plurality of coils 130. The plurality of coils 130 are connected electrically to one another in series with one another to cooperate with the plurality of teeth 120 to define the distributed poles P (shown in FIG. 6) of the core 106. In this respect the core winding 108 includes a first coil 132 and second coil 134 which cooperate with the first tooth 122 and the second tooth 124 to define the first distributed pole P1 (shown in FIG. 3), and a third coil 136 and a fourth coil 138 which cooperate with the third tooth 126 and the fourth tooth 128 to define the second distributed pole P2 (shown in FIG. 3). In certain embodiments the core 106 have no permanent magnets, the distributed poles P being defined only when the flows through the core winding 108. In accordance with certain embodiments, the core winding 108 can be a control winding arranged to cooperate with permanent magnets carried by the core body 114. It is also contemplated that core winding 108 can be a field winding or an excitation winding, as suitable for an intended application.

With reference to FIG. 3, a portion of the core 106 is shown. The first coil 132 is seated circumferentially about the first tooth 122 and the second tooth 124. The second coil 134 is seated about the second tooth 124 and not the first tooth 122. As a consequence, when the current flow I is provided to the core winding 108, the first tooth 122 and the second tooth 124 become magnetized with a common polarity to define the first distributed pole P1. Similarly, the third coil 136 is seated circumferentially about the third tooth 126 and the fourth tooth 128, and the fourth coil 138 is seated circumferentially about the fourth tooth 128 and not the third tooth 126. This causes the third tooth 126 and the fourth tooth 128 to become magnetized with a common polarity opposite that of the first distributed pole P1 to define the second distributed pole P2. It is contemplated that each of the plurality of coils 130 be connected electrically in series with one another such a current flow from a current source in electrical communication with the plurality of coils 130, e.g., a current source 140, define the distributed poles P distributed circumferentially about the periphery of the core 106. Further, although the first distributed pole P1 and the second distributed pole P2 are shown as having two (2) teeth and two (2) coils, it is to be understood and appreciated that the distributed poles P of the core 106 can have more than two (2) teeth and/or more two (2) coils, as suitable for an intended application.

As will be appreciated by those of skill in the art in view of the present disclosure, the shape and peak magnetic flux communication capability of the distributed poles P is a function of both circumferential span and the number of turns included in the coils seated on the plurality of teeth 120. In the embodiment shown in FIG. 3 each of the plurality of the distributed poles P, e.g., the first distributed pole P1, include a plurality of teeth, e.g., the first tooth 122 and the second tooth 124, and a plurality of coils, e.g., a first coil 132 and a second coil 134, the plurality of coils having an equivalent number of turns. Defining the first distributed pole P1 with a plurality of teeth allows a pole arc 142 of the first distributed pole P1 to be larger than a circumferential span of 144 of the first tooth 122 and a circumferential span 146 of the second tooth 124, the first distributed pole spanning the first tooth 122 and the second tooth 123. This limits density of magnetic flux, improving efficiency of electric machines constructed with the core 106. Further, plurality of coils 130 can each be relatively small, limiting the load exerted by the plurality of coils 130 on the core body 114 during rotation—limiting stress and/or rendering the core 106 capable of supporting relatively high rotational speeds.

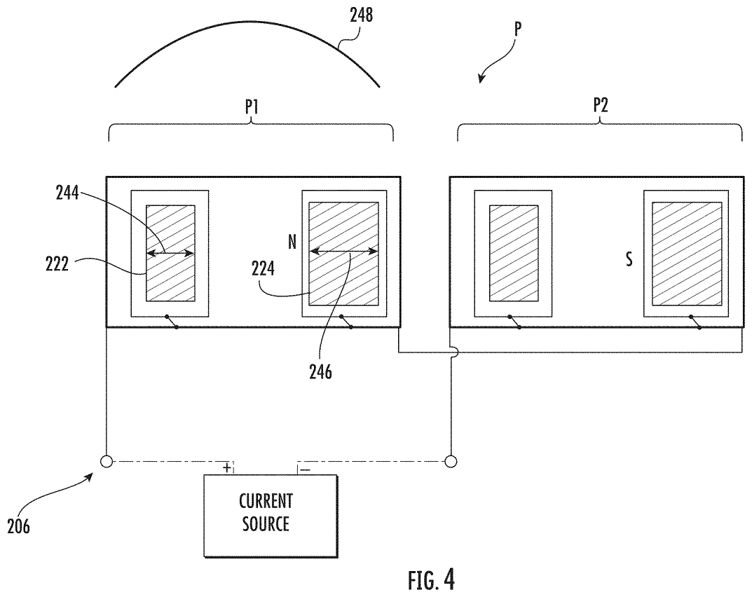

With reference to FIG. 4, a core 206 is shown. The core 206 is similar to the core 106 (shown in FIG. 2) and additionally includes a plurality of the distributed poles P each defined by rotor teeth with different circumferential span. In this respect the first distributed pole P1 is defined by a first tooth 222 and a second tooth 224. The first tooth 222 has a first circumferential span 244 and the second tooth has a second circumferential span 246, the second circumferential span 246 being greater than that of the first circumferential span 244. The differently sized circumferential spans of the first tooth 222 and the second tooth 224 impart shaping of a magnetic pole arc 248 defined by the first distributed pole P1 circumferentially spanning the first tooth 222 and the second tooth 224, which provides a parameter to define the shape of the sinusoidal voltage waveform 24 (shown in FIG. 1) provided to the electrical load 14 (shown in FIG. 1) connected to the electric machine 100 (shown in FIG. 1). Further, when the electric machine 100 is arranged to provide DC power to the DC electrical load 16 (shown in FIG. 1), the shape of the magnetic pole arc 248 can be selected to define the shape of the trapezoidal voltage waveform 26 (shown in FIG. 1) provided to the DC electrical load 16.

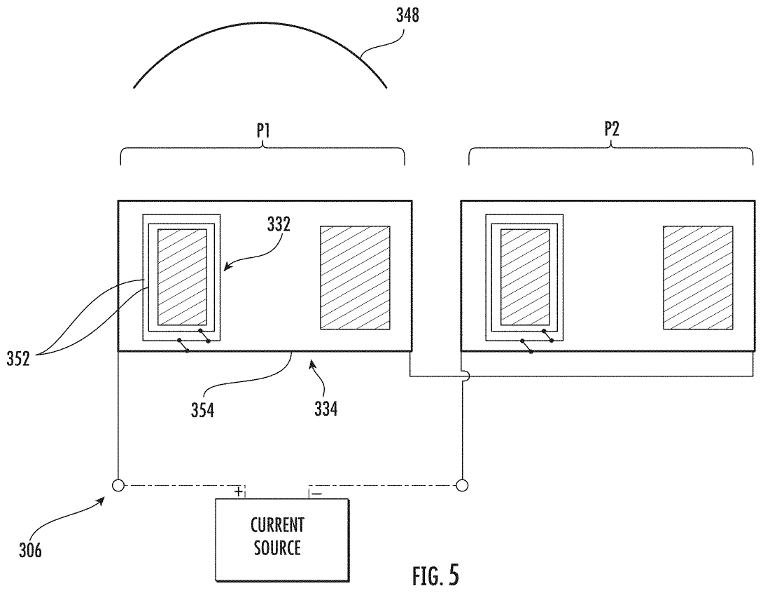

With reference to FIG. 5, a core 306 is shown. The core 306 is similar to the core 106 (shown in FIG. 2) and additionally includes a plurality of the distributed poles P each defined by coils having different numbers of turns. In this respect the first distributed pole P1 is defined by a first coil 332 and a second coil 334. The first coil 332 has two (2) first coil turns 352 and the second coil 334 has one (1) second coil turn 354. The different number of first coil turns 352 of the first coil 332 and second coil turns 354 of the second coil 334 impart shaping of a magnetic pole arc 248 defined by the first distributed pole P1, which provides a parameter to define the shape of the sinusoidal voltage waveform 24 (shown in FIG. 1) provided to the electrical load 14 (shown in FIG. 1) connected to the electric machine 100 (shown in FIG. 1). Further, when the electric machine 100 is arranged to provide DC power to the DC electrical load 16 (shown in FIG. 1), the shape of the magnetic pole arc 248 can be selected to define the shape of the trapezoidal voltage waveform 26 (shown in FIG. 1) provided to the DC electrical load 16. Although coils of having two (2) and one (1) turn are shown in FIG. 5, it is to be understood and appreciated that embodiments of cores described herein can have distributed poles formed by coils having different numbers of turns than shown in FIG. 5 and remain within the scope of the present disclosure. Further, it is to be understood and appreciated that embodiments of cores described herein can have distributed poles with both teeth of different circumferential span and with coils having different numbers or turns, and remain within the scope of the present disclosure.

With reference to FIG. 6, the core 106 is shown according to an embodiment. As shown in FIG. 6 the core 106 has twenty-four (24) teeth 120 and twenty-four (24) coils 130 fixed to the core body 114 to define twelve (12) distributed poles P. This allows the core 106 to serve as a spare (or upgrade) for generator-type electric machines having 12-pole rotors. As shown in FIG. 6, the core 106 also has a damper winding 160, which provides reduces (or eliminates entirely) the tendency of electrical load changes to change the rotational speed of the core 106.

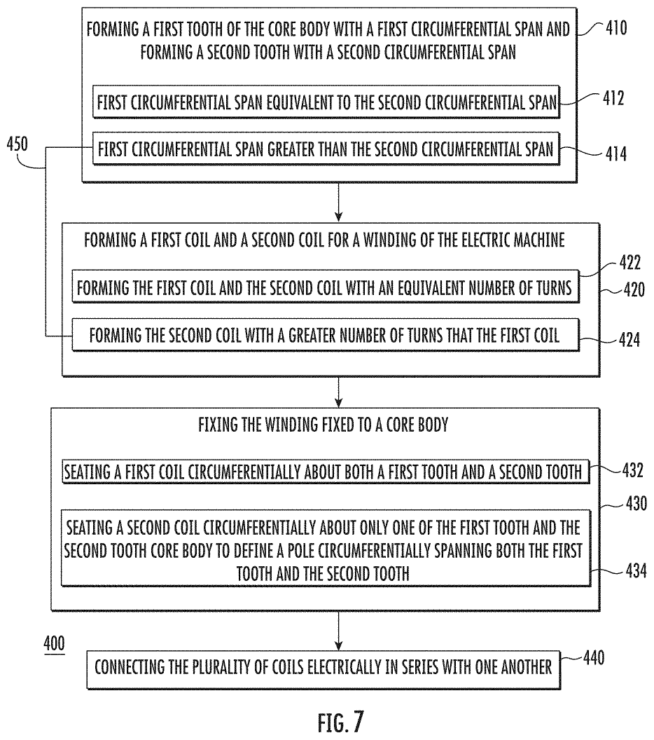

Referring now to FIG. 7, a method 400 of make a core for an electric machine, e.g., the core 106 (shown in FIG. 2) for the electric machine 100 (shown in FIG. 1), is shown. The method 400 include forming a first tooth and a second tooth o the core body, e.g., the first tooth 122 (shown in FIG. 2) and the second tooth 124 (shown in FIG. 2), as shown with box 410. The method 400 also includes forming a first coil and a second coil of a winding for the core of the electric machine, e.g., the first coil 132 (shown in FIG. 2) and the second coil 134 (shown in FIG. 2) of the core winding 108 (shown in FIG. 2), as shown with box 420. The method 400 additionally includes fixing the winding to the core body, as shown with box 430.

As shown with box 410, the circumferential span of the teeth forming the distributed poles of the core can be selected for shaping pole arc of the poles of the core. For example, a first circumferential span of the first tooth can be selected such that first circumferential span is equivalent to a second circumferential span of the second tooth, as shown with box 412. The first circumferential span can be selected such that the first circumferential of the first tooth is greater than the second circumferential span of the second tooth, as shown with box 414.

As shown with box 420, the number of turns of the coils defining the distributed poles of the core can be selected for shaping pole arc of the distributed poles of the core. For example, as shown with box 422, the first coil and the second coil can be formed with equivalent numbers of turns. The first coil and the second coil can be formed with different numbers of turns, as shown with box 424. It is also contemplated that the each of distributed poles be defined with teeth having different circumferential span and with coils having different circumferential span, as shown with bracket 450.

As shown with boxes 432 and 434, the winding is fixed to the by seating the first coil about both the first tooth and the second tooth, and seating the second coil about only one of the first tooth and the second tooth. The distributed pole is thereafter defined by connecting the plurality of coils of the winding in series with one another and a current source, e.g., the current source 140 (shown in FIG. 3), as shown with box 440.

Poles in electric machines are commonly established by flowing electric current through a winding formed from singular coils wrapped about singular teeth. In embodiments described herein distributed poles are defined in an electric machine using two or more teeth and two or more coils for each distributed pole. In certain embodiments, the teeth defining the distributed poles of the electric machine can have different circumferential span to cooperatively define the pole arc to accommodate an intended amount of magnetic flux communicated from the distributed pole and/or shape the magnetic pole. In accordance with certain embodiments, the coils defining the distributed poles of the electric machine have different numbers of turns to accommodate an intended amount of magnetic flux communicated from the distributed poles and/or shape the magnetic pole. It is contemplated that distributed poles provide relatively large pole arc, improve manufacturability/windability, and/or allow the electric machine to support higher rotational speed due to the relatively wedges and coils employed in the electric machine. In generator-type electric machines, the shaping provided by the distributed magnetic poles can in turn improve the shape of the voltage waveform provided by the generator, e.g., the second order fit of a sinusoidal voltage waveform provided to AC electrical loads or flatness/slope of a trapezoidal voltage waveform provided to DC electrical loads.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A core for an electric machine, comprising:
a core body arranged along a rotation axis, the core body having a plurality of teeth including at least a first tooth and a second tooth circumferentially spaced from one another about the rotation axis; and
a winding fixed to the core body and having a plurality of coils connected electrically in series with one another, one of the plurality of coils seated circumferentially about both the first tooth and the second tooth to define a distributed pole circumferentially spanning both the first tooth and the second tooth.

2. The core as recited in claim 1, further comprising a current source in electrical communication with the winding, wherein the winding defines a plurality of distributed poles arranged circumferentially about the rotation axis.

3. The core as recited in claim 2, wherein each of the plurality of distributed poles of the core is defined by two or more teeth of the core.

4. The core as recited in claim 2, wherein each of the plurality of distributed poles is defined by two or more coils of the winding.

5. The core as recited in claim 2, wherein the winding and the core body cooperatively define twelve (12) distributed poles, wherein the core body has twenty-four (24) teeth, and wherein the winding has twenty-four (24) coils.

6. The core as recited in claim 1, wherein the first tooth has a first circumferential span, wherein the second tooth has a second circumferential span, and wherein the second circumferential span is equivalent to the first circumferential span.

7. The core as recited in claim 1, wherein the first tooth has a first circumferential span, wherein the second tooth has a second circumferential span, and wherein the second circumferential span is greater than the first circumferential span.

8. The core as recited in claim 1, wherein the first coil comprises a plurality of first coil turns, wherein the second coil comprises a plurality of second coil turns, wherein the plurality of second coil turns is equivalent to the plurality of first coil turns.

9. The core as recited in claim 1, wherein in the core comprises a plurality of laminations axially stacked along the rotation axis, and further comprising a shaft arranged along the rotation axis, the core body seated on the shaft.

10. The core as recited in claim 1, wherein the winding is one of a field winding, an excitation winding, or a control winding.

11. The core as recited in claim 1, further comprising a damper winding seated in the core body.

12. The core as recited in claim 1, wherein the core has no permanent magnets fixed to the core body.

13. An electric machine, comprising:
a stator with a stator winding;
a core as recited in claim 1, wherein the stator extends about the rotation axis and the core is supported for rotation about the rotation axis relative to the stator; and
a current source in electrical communication with the winding.

14. The electric machine as recited in claim 13, wherein the winding and the rotor cooperate to generate a sinusoidal voltage waveform for an alternating current electrical load connected to the stator winding.

15. The electric machine as recited in claim 13, wherein the winding and the rotor cooperate to generate a trapezoidal voltage waveform for a direct current electrical load connected to the stator winding.

16. The electric machine as recited in claim 13, further comprising one of an alternating current electrical load and a direct current electrical load connected to the stator winding.

17. A method of making a core for an electric machine, comprising:
at a core body arranged along a rotation axis, the core body having a plurality of teeth including at least a first tooth and a second tooth circumferentially spaced from one another about the rotation axis,
fixing a winding fixed to the core body, wherein fixing the winding to the core body includes seating a first of the plurality of coils circumferentially about both the first tooth and the second tooth to define a distributed pole circumferentially spanning both the first tooth and the second tooth; and
connecting the plurality of coils electrically in series with one another.

18. The method as recited in claim 17, further comprising shaping the distributed pole by forming the first tooth with a first circumferential span and the second tooth with a second circumferential span greater than the first circumferential span.

19. The method as recited in claim 17, further comprising shaping the distributed pole by forming the first coil with a greater number of turns than the second coil.
